(19) United States
(12) Patent Application Publication
(10) Pub. No.: US 2024/0412011 A1
(43) Pub. Date: Dec. 12, 2024

(54) UNIFORM RESOURCE LOCATOR (URL) EMBEDDINGS FOR ALIGNING PARALLEL DOCUMENTS

(71) Applicant: Microsoft Technology Licensing, LLC, Redmond, WA (US)

(72) Inventors: Hieu Trong Hoang, Seattle, WA (US); Marcin Junczys-Dowmunt, Seattle, WA (US); Anthony Aue, Seattle, WA (US)

(73) Assignee: Microsoft Technology Licensing, LLC, Redmond, WA (US)

(21) Appl. No.: 18/332,672

(22) Filed: Jun. 9, 2023

(51) Int. Cl. G06F 40/58; G06F 16/955; G06F 40/205

(52) U.S. Cl. CPC G06F 40/58; G06F 16/9566; G06F 40/205

(57) ABSTRACT

Systems and methods are provided for implementing URL embeddings for aligning parallel documents that are corresponding web pages in at least two different languages. A computing system uses a pre-trained model of an AI system to calculate URL embeddings for each URL among a plurality of URLs. The system identifies, based on closeness of the points represented by the URL embeddings, a set of candidate parallel URLs by analyzing the URL embeddings for the plurality of URLs or for a second plurality of URLs that has been partitioned into a cluster, using a clustering algorithm. A set of parallel URLs, associated with the parallel documents, is selected from the identified set of candidate parallel URLs. Document text and/or parallel sentences are extracted from web documents associated with the set of parallel URLs to train a machine translation model for translating between two or more languages.

### BACKGROUND

In an interconnected world in which a large number of languages are used, understanding content regardless of language has become important. To that end, use of machine language translation (also referred to as “machine translation” or MT) is key to breaking down these language barriers. However, identifying training data, across multiple languages, for training such MT models remains a challenge. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for implementing uniform resource locator (“URL”) embeddings for aligning parallel documents that are corresponding web pages in different languages. In one embodiment, a system uses a pre-trained artificial intelligence (“AI”) model to calculate URL embeddings for each URL among a plurality of URLs. The URL embedding is a vector that represents a point in a multidimensional space. The system then identifies a set of candidate parallel URLs by analyzing the URL embeddings for the plurality of URLs based on closeness of the points represented by the URL embeddings. Subsequently, the system selects a set of parallel URLs from the identified set of candidate parallel URLs. The set of parallel URLs is associated with parallel documents that are corresponding web pages in at least two different languages. In examples, the system first uses a clustering algorithm that is used to partition the plurality of URLs into a plurality of clusters, and then the set of candidate parallel URLs is identified by analyzing a second plurality of URLs that has been partitioned into a cluster among the plurality of clusters based on the closeness of the points represented by the URL embeddings. Document text, such as parallel sentences, from web documents corresponding to the selected set of parallel URLs is extracted. The parallel sentences may then be used to train a translation model of a machine language translation system to translate subsequently received words and phrases from a first language to a second language.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing URL embeddings for aligning parallel documents that are corresponding web pages in different languages.

FIG. 2 depicts a block diagram illustrating an example data flow for implementing URL embeddings for aligning parallel documents that are corresponding web pages in different languages for training a translation model.

FIG. 3 depicts a block diagram illustrating an example data flow for training a model of an AI system to implement URL embeddings for aligning parallel documents that are corresponding web pages in different languages.

FIGS. 4A-4C depict example methods for implementing URL embeddings for aligning parallel documents that are corresponding web pages in different languages and for training an AI model to calculate the URL embeddings, respectively.

FIG. 5 depicts a block diagram illustrating example physical components of a computing device with which aspects of the technology may be practiced.

### DETAILED DESCRIPTION OF CERTAIN EMBODIMENTS

As briefly described above, machine-translation (“MT”) models provide an incredible technological advance that allows for translations between almost any two languages to be performed by a computing device. The MT models, however, only work well if they are adequately trained. Training of the MT models is performed with training data that includes content in a first language and equivalent content in a second language. This equivalent content in different languages may be referred to as “parallel” content. For instance, a parallel sentence is a sentence pair in two different languages which are translations of each other. A parallel corpus for a particular language pair is a set of document pairs or sentence pairs in those two languages. The availability of large, high-quality parallel corpora, and for more language pairs, are useful elements in the creation and training of high-quality MT models. As described herein, an AI model (e.g., an encoder model of a pre-trained neural machine translation (“NMT”) model) is trained and used to calculate URL embeddings that are ultimately used to identify parallel documents that may be subsequently used to train the MT models to improve machine translations between two or more different natural languages. Natural language, as used herein, refers to any language that has evolved naturally in humans through use and repetition, and differs from constructed languages (e.g., computer program languages).

Potential sources of such parallel corpora may be found throughout web documents (e.g., web pages) publicly available via the Internet. Many domains may publish web document pairs that have parallel data or content. For instance, a first web document may be in English, and a second, equivalent web document may be in French. While these web documents have equivalent content, the web documents are available at different URLs. Because the web documents have the same underlying content, but for the difference in language, these web documents serve as excellent sources for parallel sentences or content to form parallel corpora.

There is often a pattern between the URLs of parallel documents. For example, the following are URLs for parallel documents in English and French:

http://amta98.org/en/program.html
http://amta98.org/fr/program.html.

In this case, the difference is small and trivial. The URL of the second document can be found by changing the language identifier (“ID”) in the URL of the first. Though these simple URL pairs do occur in many websites, this does not account for patterns seen in many others. Other websites contain URL pairs that are partial translation of each other, for example:

https://www.theghotel.ie/contact.html
https://www.theghotel.ie/kontakt.html.

Yet other websites may have URL pairs that contain phrases which are translations of each other, for example:

https://www.amarillasbolivia.net/guide/potosi/argentine_restaurants.htm
https://www.amarillasbolivia.net/gelbe_seiten/potosi/argentinische_restaurants.htm.

In these cases, a simple algorithm that replaces the language ID (‘en’ with ‘fr’) is not sufficient. Accordingly, the URL pair search algorithm discussed herein takes into account the translation of words and phrases in the URLs in order to find suitable pairs rather than relying on simple substitutions.

In addition, even with a search algorithm that can properly identify the web-document pairs, due to the vast resources of the Internet, identifying such web-document pairs must be constrained in a manner to reduce the computing resources and time required to perform the identification. To increase efficiency, the disclosed technology may use pre-collected archives of web-crawled documents. Herein, “pre-collected” refers to collection of the web-crawled documents prior to implementing the URL embeddings as described herein. Web-crawling, as used herein, refers to systemic browsing of webpages to learn what each page on a website is about, so that such information can be indexed, updated, and retrieved when a search query is received. Some examples of such pre-collected archives include Common Crawl or the Internet Archive®. While the pre-collected archives include only a subset of pages from the Internet, which also may be stale, such pre-collected archives still provide a massive amount of web documents from which parallel content can be extracted. In addition, the use of the pre-collected archive reduces the need to crawl the Internet, which consumes computing resources as well as time due to the millions or billions of webpages through which to crawl and which requires creation of a database to store the resultant collected web document data. As another benefit, the pre-collected archives often pre-process the web documents within the archive. For example, the web archives may tag each web document with a language identification, which may be used by the present technology in identifying web document pairs.

The archives also include an index of the URLs for the web documents within the archive. From this index, the present technology is able to identify parallel URL pairs without having to inspect or analyze the content of the corresponding web documents. That is, the identification of web-document pairs can be done without having to download or even access the web documents themselves. As compared to other works, this advantage provides significant savings of computing resources by not having to extract the content from the HyperText Markup Language (“HTML”). Further, the computational cost of analyzing the text of the web documents is also avoided. Further, the pre-collected archive represents a closed set or closed universe of documents that does not need to be updated due to changes in the set (e.g., due to added, deleted, and/or updated webpages) in the case that the set is open or dynamic. With the closed set of documents, searching can be performed more efficiently and more easily, particularly with a full archive containing a list of already indexed URLs.

Without processing the web documents themselves, identification of web-document pairs from the URLs alone is challenging. The present technology uses the URL information in the index to align documents in preference to the full archive and to identify web-document pairs based on their URLs. To do so, the presently disclosed technology calculates URL embeddings for the URLs in the index. The URL embeddings are vectors of a predefined length of numbers (e.g., floating point numbers) that represent a point in a multidimensional space. Accordingly, the URL embeddings may be considered to represent the underlying meaning or context of the URL irrespective of language. As a result, URL embeddings that are close to one other in the multidimensional space are more likely to be equivalent and to correspond to web-document pairs. A URL embedding is thus a numeric representation of the meaning of a URL within a vector space. Inside this vector space, URLs with similar meaning will be close to each other, while URLs that are far apart in meaning will be located at a larger distance from each other, according to a vector distance metric. A multi-layer neural network model may be used to calculate the URL embeddings. The URL embedding-generation model is trained on data including URL pairs of previously collected documents that are known to be parallel. The aim of the model is to create URL embeddings for URLs such that URLs of parallel documents are closer to each other than non-parallel document pairs.

Once URL embeddings are calculated for the URLs in the index, the system searches for close URL embeddings corresponding to URL pairs that are indicative of parallel documents. The documents are then sent downstream in a parallel corpus extraction pipeline where their parallelism is verified and the bilingual data is extracted. Bilingual data is then used to train MT models for translating between the pair of languages. Although parallel pairs are described above, the system is capable of embedding multiple (e.g., three or more) parallel languages, referred to herein as “parallel sets.” Likewise, for URL embeddings for three or more corresponding documents each of which being in one of three or more languages, the term “document sets” is used instead of “document pairs.” Training a model requires a fair amount of computing resources, which is costly. After significant work is performed to train the model, the model has to be stored. Training a model to find parallel pairs (or document pairs) means that one has to embed the URLs in a first language and also in a second language, then search for correspondences. This process is repeated for the first language and a third language and their correspondences, and so on. Training a single multilingual model for a large set of languages has a number of advantages and efficiencies. By training one model that knows how to embed URLs from all the languages of interest and to do so in the same vector space [referred to herein as the “single model approach”], the URLs in any one language are only embedded once for all other languages, and the computation of that URL embedding can be reused over and over when searching for other language pairs or set. A major advantage of the single model approach is the computational efficiency and the search in terms of finding the closest URL to all other languages or all languages in a subset of languages, without having to run multiple searches across different specific language pairs. The single model approach enables efficient computation of parallel corpora, not only for faster computation of a first language to a second language (e.g., <en> to <XX>), but also for all n² language pairs in a batch. Further efficiencies may be gained by focusing the analysis or comparison of URL embeddings on URLs associated with a single network domain, in particular, the host portion of the URLs (e.g., “domain” in “www.domain.com”). Clustering algorithms further narrow a pool of URLs to analyze.

The technology described herein reduces the amount of processing, thereby improving compute efficiency gains, for generating URL embeddings for subsequent machine translation model training from a whole document to just the URL of the document. In an example, calculating URL embeddings from URLs of webpages and identifying parallel document candidates based on computed vector similarities between URL embeddings, rather than sentences or document text contained within the webpages or web documents themselves contributes to reducing the amount of processing. Parallel document candidates, as used herein, refers to pairs or sets of documents that, based on the computed vector similarities, are determined to be potential parallel pairs or sets. Without digging into the content of the web documents, which can be processing intensive, and relying on only the URLs or the URL embeddings based on the URLs, there is, in some cases, uncertainty as to matching of URLs as parallel pairs or sets. Such uncertainty gives rise to an initial classification of the potential parallel pairs or sets as parallel document candidates.

In another example, classifying URLs from a collection of URLs contained in a metadata index of a pre-collected archive of web documents into URLs for a single network domain alternatively or additionally contributes to the reduction in the amount of processing, particularly compared to first crawling the Internet for the web documents then performing classification on a dynamic set of URLs. Further to the description of pre-collected archives above, the pre-collected archive of web documents, as used herein, refers to web documents that have previously been web-crawled (in some cases, by third party services including Common Crawl or the Internet Archive®) and often includes pre-processed web documents that typically include language tags. Partitioning URLs that are in one language (e.g., source language) into a plurality of clusters, using a clustering algorithm (e.g., k-means clustering algorithm) prior to determining vector distances between URLs of another language(s) (e.g., target language(s)) and identifying and assigning URLs of the another language(s) into the most relevant clusters (e.g., based on cosine similarity calculations) may also serve to reduce the amount of processing. Alternatively or additionally, the amount of processing may be further reduced by using a weighted bipartite matching algorithm (e.g., competitive linking algorithm). In the case that a URL contains multiple languages, the AI model may be further trained to determine whether the URL corresponds to a source language or a target language. In an example, a URL containing words in English and German may be determined by the AI model to correspond to the German language, particularly where the host portion (or domain name portion) of the URL contains English and the path portion following the host portion of the URL contains at least one German word or phrase.

The technology, unlike existing models, uses most, if not all, of the information that is in the URL, including translational correspondences, rules, and other information. The embedding space provides this information automatically after the URL embedding process. The URL-based model is dramatically faster and much more efficient than the document-based models. Because it is faster and more efficient, the URL-based model can repeat the URL embedding process over multiple archives or databases faster than the document-based models can do so over a single database. As such, the URL-based model can identify significantly more parallel pairs or sets, while using the same amount of resources as the document-based models.

Various modifications and additions can be made to the embodiments discussed without departing from the scope of the disclosed techniques. For example, while the embodiments described above refer to particular features, the scope of the disclosed techniques also includes embodiments having different combination of features and embodiments that do not include all of the above-described features.

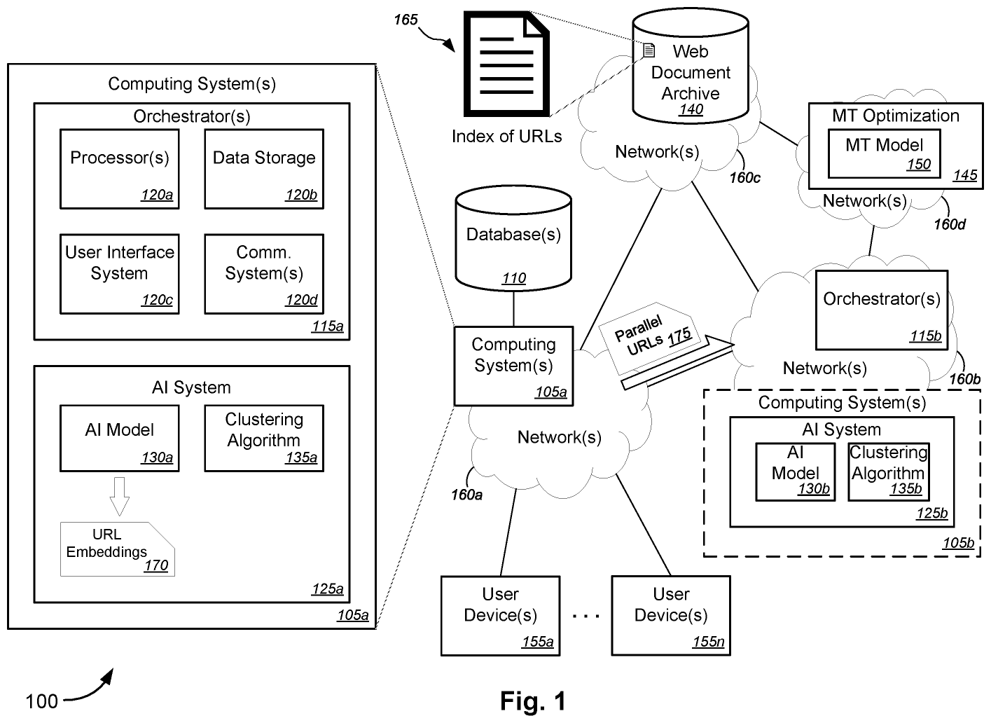

We now turn to the embodiments as illustrated by the drawings. FIGS. 1-5 illustrate some of the features of a method, system, and apparatus for implementing MT optimization, and, more particularly, to methods, systems, and apparatuses for implementing URL embeddings for aligning parallel documents, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example system 100 for implementing URL embeddings for aligning parallel documents that are corresponding web pages in different languages. System 100 includes one or more computing systems 105a and 105b (collectively, “computing systems 105”) and at least one database 110, which may be communicatively coupled with at least one of the one or more computing systems 105. In some examples, computing system 105a may include orchestrator 115a, which may include at least one of one or more processors 120a, a data storage device 120b, a user interface system 120c, and/or communications system 120d. In some cases, computing system 105a may further include an artificial intelligence (“AI”) system 125a. The following examples primarily refer to AI models and systems, but it should be understood that such AI models and systems may include machine learning (“ML”) models and systems.

The AI system 125a uses an AI model 130a (e.g., a neural machine translation (“NMT”) model) and also, in some cases, a clustering algorithm 135a. The NMT model is a machine translation model that is based on an approach that uses an artificial neural network to predict likelihood of a sequence of words, typically modeling entire sentences in a single integrated model.

The orchestrator 115a and the AI system 125a may be disposed, located, and/or hosted on, or integrated within, a single computing system. In some examples, the orchestrator 115a and the AI system 125a may be a co-located (and physically or wirelessly linked) set of computing systems (such as shown in the expanded view of computing system 105a in FIG. 1). In other examples, the components of computing system 105a may be embodied as separate components, devices, or systems, such as depicted in FIG. 1 by orchestrator 115b and the AI system 125b being separate components. For example, AI system 125b (using AI model 130b and/or cluster algorithm 135b) may be disposed, located, and/or hosted on, or integrated within, computing system 105b. In some examples, orchestrator 115b and computing system 105b are separate from, yet communicatively coupled with, each other. Orchestrator 115b, AI system 125b, AI model 130b, and clustering algorithm 135b are otherwise similar, if not identical, to orchestrator 115a, AI system 125a, AI model 130a, and clustering algorithm 135a, respectively. Although FIGS. 1-3 depict the use of an AI model(s) 130a or 130b, any of the suitable models as described above (e.g., the NMT model, LMs, or LLMs) or other equivalent models may be used.

In examples, system 100 includes a web document archive 140 and an MT optimization system 145 that is used to train, update, and optimize a translation model or MT model 150. Web document archive 140, as used herein, refers to a database (such as web page repositories Common Crawl or Internet Archive®, as described above) that contains web documents (e.g., web pages) as well as an index 165 of URLs. In some examples, the index 165 of URLs includes a metadata index of URLs. In some cases, the metadata includes the URLs themselves. The web is vast, so keeping or storing all the content is extremely expensive. In examples, web-crawling is performed, followed by deletion of the content, keeping only a record of where content is stored (e.g., the URL), to save space and costs compared with keeping or storing all the content. Parallel data is searched using only data from an address book (e.g., the URL) rather than searching the contents of the web documents themselves. Knowing the address from the address book, the content can be requested from said address. Once the parallel pairs or sets have been identified, the amount of content that has to be extracted or found is greatly reduced. As such, there is no need for the content until the parallel pairs or sets have effectively been identified. Access to the content can be casually or lazily regained once such content is actually required. To the extent that index data is available, it could be used in this approach in any context. It could be an archive, any set of index data, or source addresses. The URL embedding process can be run using this data, without ever having to access the content. In some examples, only the metadata index is available while the web pages don't yet exist in the database. Applying the URL embedding process on only the metadata (e.g., the URLs), parallel pairs or sets may be identified, and a request for the corresponding web pages (even if it is as many as a million web pages) may be made or ordered.

In some embodiments, system 100 includes user devices 155a-155n (collectively, “user devices 155”). According to some embodiments, computing system 105a and database 110 may be disposed or located within network 160a, and orchestrator 115b and computing system 105b may be disposed or located within network 160b, while web document archive 140 may be disposed or located within network 160c, and MT optimization system 145 may be disposed within network 160d, such as shown in the example system 100 of FIG. 1. In other embodiments, computing system 105a, database 110, orchestrator 115b, computing system 105b, web document archive 140, and MT optimization system 145 may be disposed or located within the same network among networks 160a-160d. In yet other embodiments, computing system 105a, database 110, orchestrator 115b, computing system 105b, web document archive 140, and MT optimization system 145 may be distributed across a plurality of networks within network 160a-160d.

Networks 160a-160d (collectively, “network(s) 160”) may each include at least one of a distributed computing network(s), such as the Internet, a private network(s), a commercial network(s), or a cloud network(s). In some instances, the user devices 155 may each include one of a desktop computer, a laptop computer, a tablet computer, a smart phone, a mobile phone, or any suitable device capable of communicating with network(s) 160 or with servers or other network devices within network(s) 160. In some examples, the user devices 155 may each include any suitable device capable of communicating with at least one of the computing systems(s) 105a, 105b and/or orchestrator 115a, 115b, and/or the like, via a communications interface. The communications interface may include a web-based portal, an application programming interface (“API”), a server, a software application (“app”), or any other suitable communications interface (not shown), over network(s) 160.

In some embodiments, the computing systems 105a and 105b may each include at least one of an orchestrator (e.g., orchestrator 115a or 115b), a machine translation training system, a machine translation optimization system (e.g., MT optimization system 145), a server, an AI system (e.g., AI systems 125a and/or 125b), a cloud computing system, or a distributed computing system. Herein, “AI system” may refer to a system that is configured to perform one or more artificial intelligence functions, including, but not limited to, machine learning functions, deep learning functions, neural network functions, expert system functions, and/or the like.

In some examples, AI model 130a or 130b is trained, updated, and used to calculate URL embeddings 170 for URLs, each URL embedding 170 being a vector that represents a point in a multidimensional space. In examples, URL embeddings of parallel URLs are closer in value compared with URL embeddings of non-parallel URLs. Parallel URLs along with parallel documents, as used herein, refer to URLs and/or documents that are related in that the text string of the URLs and/or the content of the documents are substantially the same as the corresponding text string of the URLs and/or the corresponding content of the documents in the parallel documents, albeit expressed in different (natural) languages. Herein also, a parallel pair of URLs (or URL pair) may refer to URLs that correspond to one another in which one of the pair of URLs is in a first language while the other of the pair of URLs is in a second language that is different from the first language. Likewise, a parallel pair of documents or web pages (or document pair or web page pair) may refer to documents or web pages that correspond to one another in which one of the pair of documents or web pages is in a first language while the other of the pair of documents or web pages is in a second language. A parallel set of URLs, documents, or web pages, as used herein, is similar but refers to parallel URLs, documents, or web pages that correspond to one another in which each is in one of two or more (in some cases, three or more) languages that are different from each other.

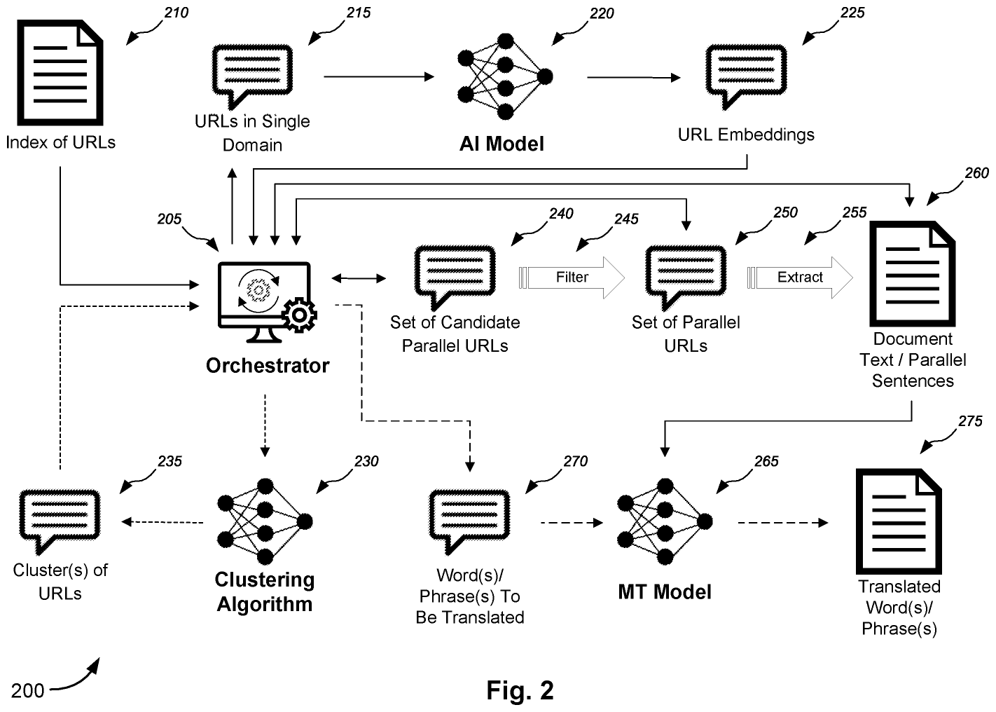

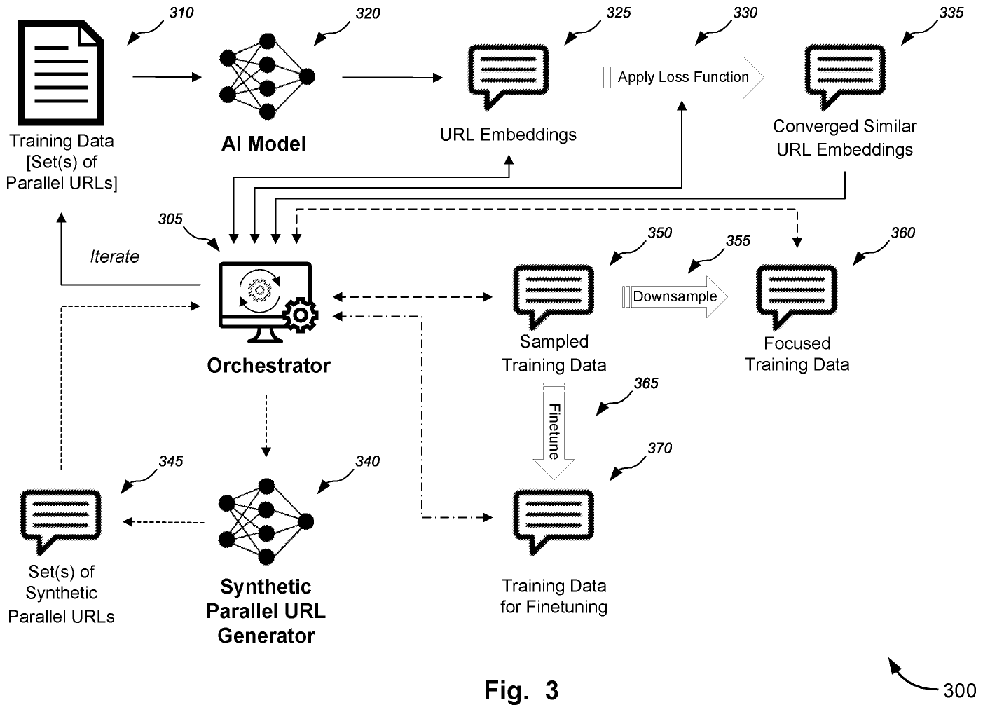

In operation, computing system 105a or 105b, and/or orchestrator 115a or 115b (collectively, “computing system”) may perform methods for implementing URL embeddings for aligning parallel documents that are corresponding web pages in different languages, as described in detail with respect to FIGS. 2-5. For example, data flows as described below with respect to FIGS. 2 and 3 may be applied with respect to the operations of system 100 of FIG. 1. The example data flow 200 of FIG. 2 is directed to implementing URL embeddings for selecting a set of parallel URLs (e.g., parallel URLs 175) whose corresponding web pages are mined to extract parallel words and/or phrases in two or more different languages for use in training a translation model (e.g., MT model 150) to perform natural language machine translations between the two or more different languages. The example data flow 300 of FIG. 3 is directed to training the model of the AI system (e.g., AI model 130a or 130b) to perform the URL embedding calculations that are ultimately used for selecting the set of parallel URLs for subsequently training the translation model to perform natural language machine translations among the two or more different languages.

FIG. 2 depicts a block diagram illustrating an example data flow 200 for implementing URL embeddings for aligning parallel documents that are corresponding web pages in different languages for training a translation model. In the example data flow 200 of FIG. 2, orchestrator 205, index 210 of URLs, AI model 220, URL embeddings 225, clustering algorithm 230, sets of parallel URLs 250, and MT model 265 may be similar, if not identical, to orchestrator(s) 115a or 115b, index 165 of URLs, AI model 130a or 130b, URL embeddings 170, clustering algorithm 135a or 135b, parallel URLs 175, and MT model 150, respectively, of system 100 of FIG. 1. The description of these components of system 100 of FIG. 1 are similarly applicable to the corresponding components of FIG. 2.

With reference to the example data flow 200 of FIG. 2, an orchestrator 205 may classify or identify URLs for a single network domain (e.g., microsoft.com) to form a plurality of URLs 215. Classifying or identifying URLs for a single network domain reduces the number of URL comparisons to perform, which preserves computing resources. It is also more likely for parallel documents to be found within a single network domain rather than across multiple different domains. The plurality of URLs 215 is identified from a collection of URLs, for a plurality of network domains, that is contained in an index of a pre-collected archive of web documents, such as the index 210 of URLs. The orchestrator 205 may calculate, using a pretrained AI model 220, URL embeddings 225 for the URLs in the plurality of URLs 215. Each URL embedding 225 is a vector that represents a point in a multidimensional space, where URL embeddings 225 of parallel URLs are closer in value compared with URL embeddings 225 of non-parallel URLs. The orchestrator 205 may identify a set of candidate parallel URLs 240. In an example, the set of candidate parallel URLs 240 is identified by analyzing the URL embeddings 225 for the plurality of URLs 215 based on closeness of the points represented by the URL embeddings.

In an example, the orchestrator 205 partitions, using clustering algorithm 230 (e.g., a k-means clustering algorithm), the plurality of URLs 215 into a cluster(s) of URLs 235. The set of candidate parallel URLs 240 is identified by analyzing the URL embeddings 225 to generate a second plurality of URLs (which is a subset of the plurality of URLs 215). The second plurality of URLs includes URLs that were partitioned into the cluster of URLs 235 from the plurality of URLs 215, based on closeness of the points represented by the URL embeddings. In some embodiments, identifying the set of candidate parallel URLs includes identifying, from the cluster 235, a first subset of URLs that corresponds to a first language (e.g., top 5 URLs in the first language), by selecting URLs based on URL embeddings 225 that are determined to be most similar to each other. Identifying the set of candidate parallel URLs further includes identifying, from the cluster, a second subset of URLs that correspond to a second language (e.g., top 5 URLs in the second language), by selecting URLs based on URL embeddings 225 that are determined to be most similar to each other.

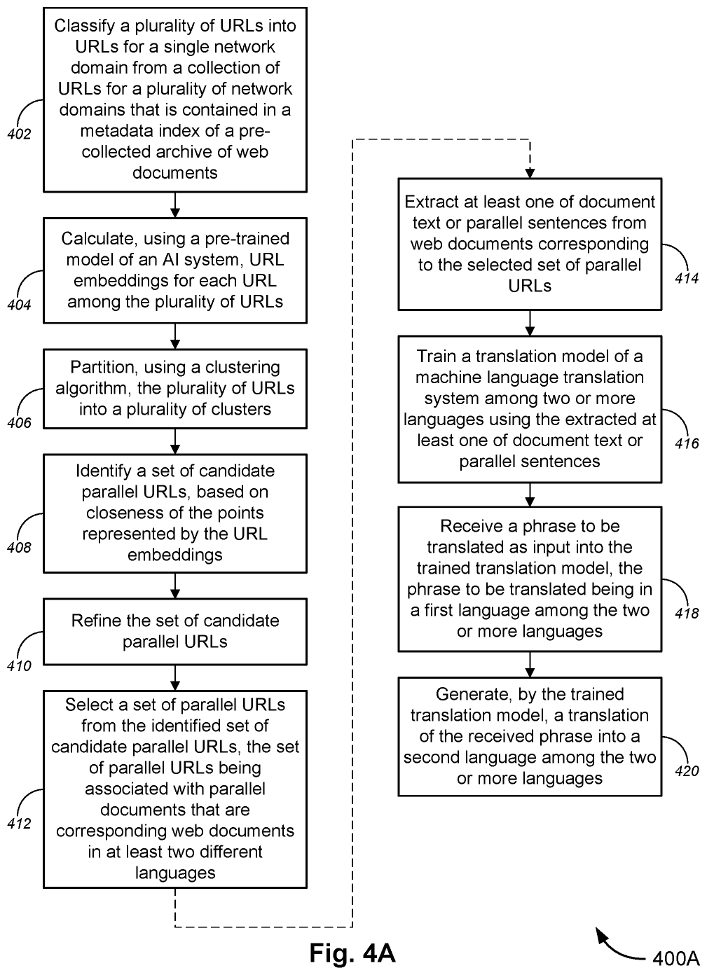

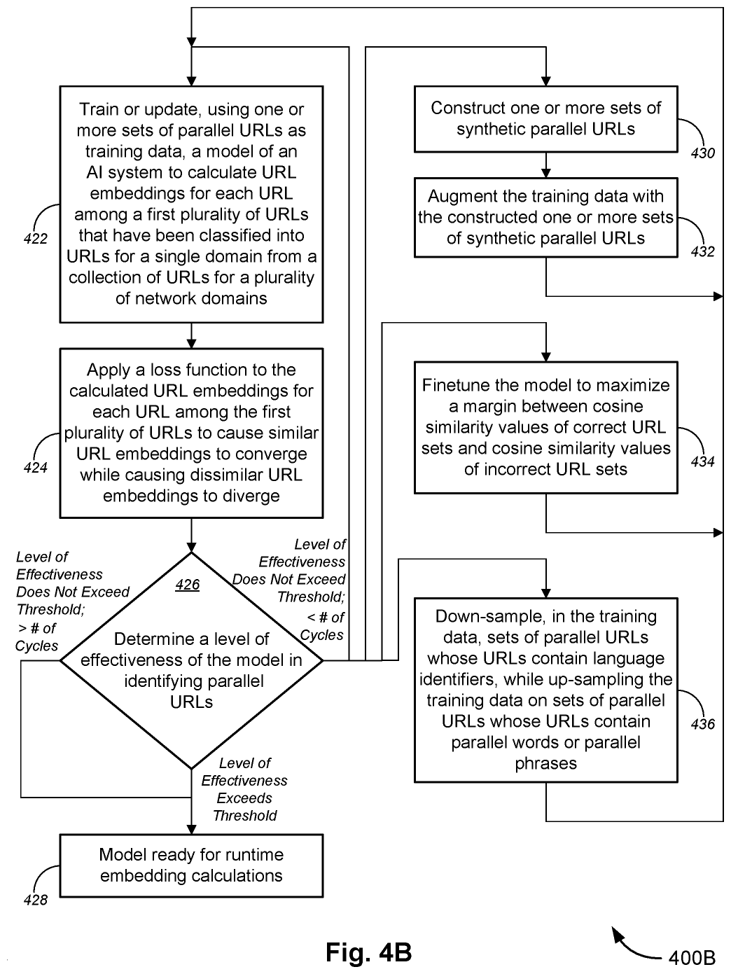

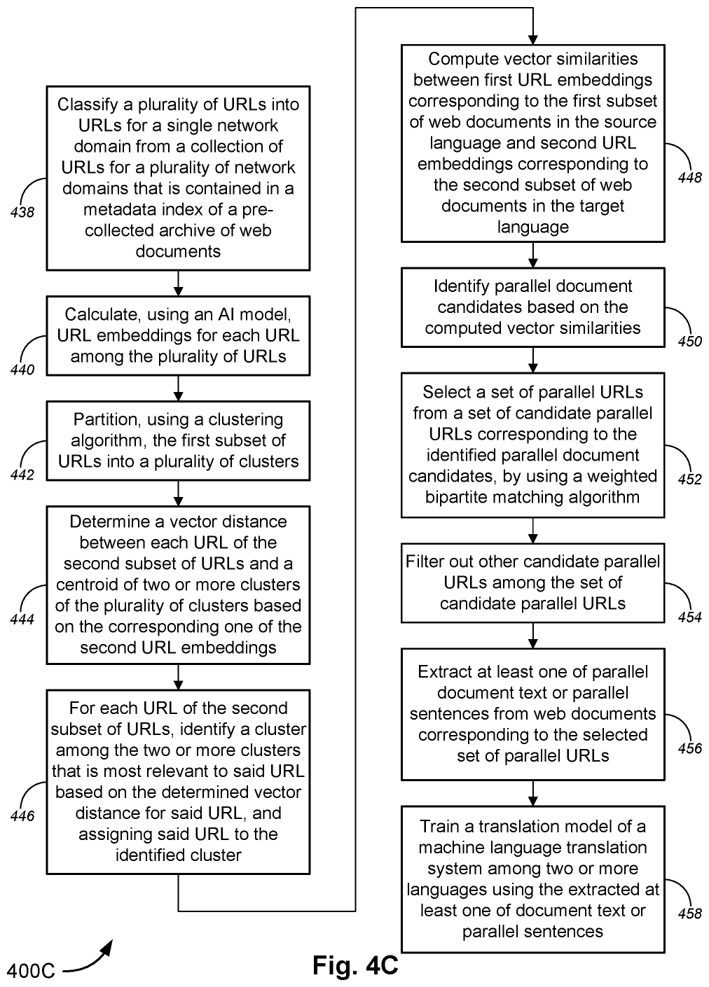

The orchestrator 205 may select a set of parallel URLs 250 from the identified set of candidate parallel URLs 240. The set of parallel URLs 250 is associated with parallel documents that are corresponding or equivalent web pages in at least two different languages. In some examples, selecting the set of parallel URLs includes selecting the set of parallel URLs 250 from the identified set of candidate parallel URLs 240, using a competitive linking algorithm to select most promising parallel URLs. Competitive linking is described in detail below with respect to FIG. 4A. At operation 245, other candidate parallel URLs (i.e., the non-selected or not most promising parallel URLs) among the identified set of candidate parallel URLs may be deleted, de-selected, or ignored. In this case, selecting the set of parallel URLs 250 includes selecting remaining URLs after less relevant URLs (e.g., the other candidate parallel URLs) have been deleted, de-selected, or ignored (at operation 245). In this manner, the other candidate parallel URLs are effectively filtered out of the list of identified set of candidate parallel URLs, leaving the most promising parallel URLs (e.g., the set of parallel URLs 250) remaining.

In examples, at operation 255, the orchestrator 205 extracts document text, such as parallel sentences 260, from web documents (e.g., web pages) corresponding to the selected set of parallel URLs 250. The extracted parallel sentences 260 are used to train a translation model 265 of a MT system for two or more languages. Subsequently, the orchestrator 205 may receive and send as input into the trained translation model 265, words or phrases 270 to be translated. The words or phrases 270 may be in a first language among the two or more languages. The trained translation model 265 then generates a translation 275 of the received words or phrases 270 into a second language of the two or more languages.

FIG. 3 depicts a block diagram illustrating an example data flow 300 for training a model of an AI system to implement URL embeddings for aligning parallel documents that are corresponding web pages in different languages. In the example data flow 300 of FIG. 3, orchestrator 305, AI model 320, and URL embeddings 325 may be similar, if not identical, to orchestrator(s) 115a or 115b, AI model 130a or 130b, and URL embeddings 170, respectively, of system 100 of FIG. 1. The description of these components of system 100 of FIG. 1 are similarly applicable to the corresponding components of FIG. 3.

Referring to the example data flow 300 of FIG. 3, an orchestrator 305 may use one or more sets of parallel URLs as training data 310 to train or update AI model 320 to calculate URL embeddings 325 for each URL among a plurality of URLs. In some cases, the plurality of URLs has been classified into URLs for a single domain from a collection of URLs for a plurality of network domains. At operation 330, the orchestrator 305 applies a loss function to the calculated URL embeddings 325 for each URL among the plurality of URLs to cause similar URL embeddings 335 to converge (in vector space) while causing dissimilar URL embeddings to diverge. A loss function, as used herein, is a mathematical function that computes the distance between two or more outputs (in this case, the distance between one calculated URL embedding 325 and one or more other calculated URL embeddings 325). Pairs or sets of URL embeddings having small differences (i.e., that are closer in vector space), especially after iteration of URL embedding calculation, correspond to the converged similar URL embeddings 335, while URL embeddings having large differences (i.e., that are farther apart in vector space), especially after iteration of URL embedding calculation, correspond to the diverged dissimilar URL embeddings. A level of effectiveness of the model in identifying parallel URLs that correspond to web documents in at least two different languages may be determined, e.g., by comparing URL pairs corresponding to the converged similar URL embeddings 335 with a set of ground truth URL pairs. The processes for updating the AI model 320 to calculate URL embeddings 325 for each URL and for determining the level of effectiveness of the model may be repeated or iterated for a set number of cycles (e.g., 5, 10, 15, 20, 25, 50, 100 cycles or iterations). Alternatively, these processes may be repeated or iterated until the determined level of effectiveness exceeds a threshold level of effectiveness (e.g., 50, 60, 70, 80, or 90% match between URL pairs and ground truth URL pairs).

In examples, neural embeddings of URLs are learned by training a neural network to map URLs to low-dimensional vectors. The neural network may be trained using a specific objective or loss function that encourages the vectors for similar entities to be close together and the vectors for dissimilar entities to be far apart. Neural embeddings are learned during supervised or unsupervised training as an intermediate representation that is most helpful for the neural network to accomplish a supervised or unsupervised task. An appropriate neural embedding model is selected, considering the specific requirements of multilingual URL representation. Models such as FastText, word2vec, or BERT, which can generate contextualized embeddings, may be used due to their effectiveness in handling multilingual data. If URL pairs are available, a supervised training approach may be employed, for instance, in translating between URL pairs. In the absence of URL pairs, an unsupervised approach, such as self-supervised learning, may be used. In an example, the AI model is then trained to predict masked tokens in the URLs or to reconstruct the original URL from corrupted versions, thereby learning meaningful representations without explicit labels. The generated URL embeddings may be utilized for similarity analysis, clustering, information retrieval, and/or other downstream applications.

In some examples, the orchestrator 305 uses a synthetic parallel URL generator 340 to construct one or more sets of synthetic parallel URLs 310. In an example, each set of synthetic parallel URLs 310 includes a first synthetic URL that is a pseudo-URL constructed from a first sentence in a first language and a second synthetic URL that is a pseudo-URL constructed from a second sentence in a second language, the second sentence being a translation in the second language of the first sentence. For example, from a parallel pair of sentences in English (“my mother taught the infants”) and in French (“ma mère faisait la petite classe”), a synthetic URL pair may be constructed as follows:

“https://www.crechesimsalabim.lu/my/mother/taughtthe/infants.asp”; and
“https://www.crechesimsalabim.lu/mamèrefaisait/lapetite/classe.asp.”

The constructed one or more sets of synthetic parallel URLs 345 are used to augment the training data 310.

In examples, at operation 355, the orchestrator 305 also performs down-sampling, in the training data 310, of sets of parallel URLs whose URLs contain language identifiers (e.g., sampled training data 350, also referred to as “easy” URL pairs or sets), while performing up-sampling, in the training data 310, of sets of parallel URLs whose URLs contain parallel words or parallel phrases (e.g., focused training data 360, also referred to as “difficult” URL pairs or sets). Down-sampling, as used herein, refers to training of the AI model to lower its reliance on some types of data (e.g., the “easy” URL pairs or sets), in some cases, by weighting such types of data lower than other types of data (e.g., the “difficult” URL pairs or sets). In contrast, up-sampling, as used herein, refers to training of the AI model to increase its reliance on some types of data (e.g., the “difficult” URL pairs or sets), in some cases, by weighting such types of data higher than other types of data (e.g., the “easy” URL pairs or sets). Herein, these “easy” URL pairs or sets already contain matching data therein save for the language identifier, and thus identifying them as parallel pairs or sets is trivial. In contrast, where parallel pairs differ due to partial or full translations of terms, words, or phrases in the URLs requires further analysis and computation to identify parallel pairs or sets, thus adding to the complexity and difficulty of the task. Hence, these types of data are referred to as “difficult” URL pairs or sets. For instance, the following example URLs for parallel documents in English and French include language identifiers (e.g., “en” and “fr” for English and French, respectively) in the URLs themselves:

“http://amta98.org/en/program.html”; and
“http://amta98.org/fr/program.html.”

Training on such “easy” URL pairs (or URL sets of two or more parallel language URLs) may adversely affect the ability of the AI model 320 to embed “difficult” URLs as the model resorts to learning character differences. Down-sampling these “easy” URL pairs (or URL sets) and focusing on or up-sampling the following “difficult” URL pairs (or URL sets) improves the functionality of the AI model 320. The following example URLs for parallel documents in English and Norwegian include a partial translation of a word(s) in the URL:

“https://www.theghotel.ie/contact.html”; and
“https://www.theghotel.ie/kontakt.html.”

The following example URLs for parallel documents in English and German include URLs that contain phrases that are translations of each other:

“https://www.amarillasbolivia.net/guide/potosi/argentine_restaurants.htm”; and
“https://www.amarillasbolivia.net/gelbe_seiten/potosi/argentinische_restaurants.htm.”

Accordingly, the system takes into account the translation of words and phrases in the URLs in order to find suitable parallel pairs (or parallel sets). It is difficult to find parallel URLs that are partially translated because there are no patterns and no rules that would, in the general case, work for finding the parallel URLs, unlike the easy case of the language identifiers in the URL. The present technology, however, enables finding of such difficult URL pairs or sets, as described herein.

At operation 365, the sampled training data 350 may be used to finetune the AI model 320 to generate training data for finetuning 370, by maximizing a margin score between cosine similarity values of correct URL sets and cosine similarity values of incorrect URL sets. The margin score is a ratio of a current score of a current pair (or set) of URLs to an average score of a chosen top N^{th} URLs. The larger the margin score, the stronger the signal (e.g., strong outlier >1) indicative of a good match. For example, a top URL that is 10 times better than the next one is a strong indication that it is a good match. Very similar results may result in a margin score that is close to or less than 1. In some examples, thresholding may be used in conjunction with margin scores, where a margin score exceeding a threshold amount (e.g., 1.0, 1.1, 1.2, 1.3, 1.4, 1.5, or greater) would indicate a likely standout for a good match. The set(s) of synthetic parallel URLs 345, the focused training data 360, and/or the finetuned training data 370 may be used by the orchestrator 305 to input training data 310 for AI model 320 during one or more iterations to generate the URL embeddings 325 for enhancing alignment of parallel documents for subsequent MT model training in translating between the two or more languages.

FIGS. 4A-4C depict example methods 400A, 400B, and 400C for implementing URL embeddings for aligning parallel documents that are corresponding web pages in different languages and for training an AI model to calculate the URL embeddings, respectively. While the techniques and procedures are depicted and/or described in a certain order for purposes of illustration, it should be appreciated that certain procedures may be reordered and/or omitted within the scope of various embodiments. The operations of methods 400A, 400B, and 400C may be performed by one or more computing devices, such as the devices discussed in the various systems above. In some examples, the operations of methods 400A, 400B, and 400C are performed by the computing device operating as the orchestrator.

Referring to example method 400A of FIG. 4A, run-time operation of the model is shown. At operation 402, a plurality of URLs is classified into URLs for a network domain (e.g., microsoft.com) from a collection of URLs for a plurality of network domains. The collection of URLs may be contained in a metadata index of a pre-collected archive of web documents. At operation 404, a pre-trained AI model of an AI system (e.g., an NMT model or other suitable model) is used to calculate URL embeddings for the URLs among the plurality of URLs. Each URL embedding is a vector that represents a point in a multidimensional space, with URL embeddings of parallel URLs being calculated or generated to be closer in value compared with URL embeddings of non-parallel URLs.

In an example, the calculation of the URL embeddings relies on an encoder-decoder model, in which an encoder component may be used to encode a “meaning” of an input sentence into a vector of numbers (e.g., the URL embeddings) as a precursor to translating the input sentence. URLs, however, are dramatically different from sentences in terms of structure, and possess unique characteristics that affect how parallel URLs are identified, such as described below with respect to false positives and finetuning. For example, using a Transformer encoder (e.g., such as the encoder in an NMT model) with 6 layers having 512 hidden dimensions (or a 512-dimensional vector) for the encoder-decoder model, the encoder-decoder model predicts the target URL by encoding the source information (in this case, the source URL). In an example, the input text is prepended with a class token (‘<cls>’) whose final hidden state is used by the decoder instated of attending to all tokens in the source. This hidden state is a representation of the entire input text and is used as the input text embedding, while the decoder is ignored. The encoder is optimized to embed URLs, rather than sentences There is a bottleneck that is forcing creation of this embedding space. Because there is this bottleneck, the encoder-decoder model can only put the encoded source information to these 512 numbers. The URL embedding will put encoded source information that are semantically similar to each other into similar locations in the vector space to maximally take advantage of the similarity in this vector space. Once through the bottleneck, the part that would predict the target URL (e.g., the part doing the decoding) may be dropped, and only the URL embeddings that result from the process are used. Once the URLs in the two or more languages are in the same vector space by generating the URL embeddings, the URL embeddings enable the trained AI model (e.g., NMT model, which is a transformer-based model) to effectively determine the closeness of these URLs across multiple languages because they are all now represented in the same vector space. This representation in the form of the URL embeddings is then used for identifying new parallel pairs or parallel sets.

In some examples, a clustering algorithm (e.g., a k-means clustering algorithm) may be used to partition the plurality of URLs into a plurality of clusters, at operation 406. At operation 408, a set of candidate parallel URLs may be identified. In an example, the set of candidate parallel URLs may be identified (at operation 408) by analyzing the URL embeddings for the plurality of URLs (from operation 404) based on closeness of the points represented by the URL embeddings. For instance, the cosine similarity of the URL embeddings in the multidimensional space may be determined. In another example, the set of candidate parallel URLs may be identified (at operation 408) by analyzing the URL embeddings for a second plurality of URLs that has been partitioned into a cluster of the plurality of clusters (extending from operation 406). In some examples, the metadata index includes a language identification token (e.g., “<en>” for English, “<fr>” for French, and so on) for a URL of at least a subset of the web documents in the pre-collected archive. In an example, identifying the set of candidate parallel URLs (at operation 408) is performed based on the language identification token for the at least a subset of the web documents. According to some embodiments, identifying the set of candidate parallel URLs (at operation 408) includes identifying, from the cluster and based on URL embeddings that are determined to be most similar to each other, a first subset of URLs that correspond to a first language, by selecting URLs and a second subset of URLs that correspond to a second language. In some embodiments, determination of most similar URL embeddings is performed based on cosine similarity calculations of the URL embeddings. In some examples, the plurality of URLs includes a first subset of URLs corresponding to a first subset of web documents in a source language and a second subset of URLs corresponding to a second subset of web documents in a target language. In such examples, the partitioning process (at operation 406) includes partitioning, using a clustering algorithm, the first subset of URLs into a plurality of clusters and assigning one or more URLs among the second subset of URLs into a cluster of the plurality of clusters, based on closeness of the points represented by the URL embeddings of the one or more URLs to a centroid of the cluster. Identifying the set of candidate parallel URLs (at operation 408) may include identifying a set of candidate parallel URLs by analyzing the URL embeddings for the one or more URLs that have been assigned to the cluster.

In some examples, the set of candidate parallel URLs may be further narrowed or refined, at operation 410. Before refining the set of candidate parallel URLs, the model tends to overly associate the results with each other, leading to a large number of false positive results, which can overwhelm the downstream data extraction pipeline. Refining the set of candidate parallel URLs enables selection of only the most promising parallel pairs or sets, while filtering out the rest. In an example, refining the set of candidate parallel URLs (at operation 410) includes finetuning the model by maximizing a margin score between cosine similarity values of correct URL sets and cosine similarity values of incorrect URL sets. Numbers digits are usually very important for identifying corresponding URLs. Usually, they will have the same numbers. Accordingly, a distinction in a digit would actually weigh far higher as exclusion criteria, compared to a general or natural language-based model where translational equivalence or the like is sought. This finetuning step would then learn to bias the model to penalize results where very small pieces of the URL are determined to be mismatches, which is not something that you would get in the general or natural language-based model. Here, there are certain features, which if different makes it immediately far less likely to be a translation or a parallel pair (or set), despite everything else looking very similar. The following example URLs illustrate almost identical URLs that are not parallel documents:

“http://www.example.com/newspaper010.html”; and
“http://www.example.com/lejournal011.html.”

An interesting effect is that the model penalizes the results so that small differences in surface form can result in large distances in vector space after finetuning, which is not typical for other kinds of models. This example of minor surface differences in otherwise identical or similar URLs leading to dramatically different URL embeddings (e.g., large distances in vector space) highlights the unique differences that URLs have compared with natural language sentences, as mentioned above.

In another example, refining the set of candidate parallel URLs (at operation 410) includes selecting the set of parallel URLs from the identified set of candidate parallel URLs, using a linking algorithm to select most promising parallel URLs; and filtering out other candidate parallel URLs among the identified set of candidate parallel URLs. A linking algorithm can be thought of as a greedy version of a bipartite matching algorithm. Bipartite matching of parallel URL pairs can be illustrated by a graph in which a first set of nodes on one side corresponds to parallel documents in a first language, while a second set of nodes on the opposite side corresponds to parallel documents in a second language. Matching of the nodes on the one side to nodes on the opposite side is then performed. For bipartite matching, one node may link to one other node and vice versa. For competitive linking, margin scores can be used to sort potential edges, and one can select the top edge (with the highest margin score) that links to nodes in the bipartite graph. Linked nodes can no longer be linked with anything else under competitive linking. If the edge with the next highest margin scores has not been linked to nodes, matching proceeds and once linked the edge can no longer link with other nodes. If the edge with the next highest margin scores has already been linked, then that edge and its linked node are ignored. The process continues until all the edges with the margin scores have been processed. In an example, if URL #1 is the best English URL for French URL #1, then it cannot also be the best URL for French URL #2. In other words, the second-best URL is no longer going to be applied once ruled out, and once the top pair for a particular URL has been identified, then that URL is removed from further consideration in the pairing process. This approach significantly reduces the number of points, resulting in a minimum number of URLs as candidate parallel URLs.

In yet another example, refining the set of candidate parallel URLs (at operation 410) includes applying a threshold on the relevance weights of the identified set of candidate parallel URLs to apply an estimated relevance weight value to each URL in the identified set of candidate parallel URLs. The least relevant URL pairs are then filtered out from the identified set of candidate parallel URLs based on the estimated relevance weight value that is applied to each URL. For example, similar to margin scores, a relevance weight below 1 may be indicative of least relevance, and URLs that have a relevance weight value below 1 may be filtered out. In other cases, relevance weight may be mapped to percentage scores of relevance between 0 (for 0%) and 1 (for 100%). In these examples, URLs that have a relevance weight value of 0.7, 0.6, 0.5, or less may be filtered out. Selecting the set of candidate parallel URLs (at operation 410) includes selecting remaining URLs after filtering out the least relevant URLs.

At operation 412, a set of parallel URLs are selected from the identified set of candidate parallel URLs (from operation 408) or from the refined set of candidate parallel URLs (from operation 410), the set of parallel URLs being associated with parallel documents that are corresponding web documents in at least two different languages.

At operation 414, method 400A includes extracting at least one of document text or parallel sentences from web documents corresponding to the selected set of parallel URLs. The extracted at least one of document text or parallel sentences (from operation 414) is then used to train a translation model of a machine language translation system between or among two or more languages (at operation 416). At operation 418, a phrase to be translated is received as input into the trained translation model, the phrase to be translated being in a first language among the two or more languages. At operation 420, the trained translation model is used to a translation of the received phrase into a second language among the two or more languages.

With reference to example method 400B of FIG. 4B, training of the model is shown. At operation 422, one or more sets of parallel URLs are used as training data (instead of using sentences as training data) to train or update a model of an AI system (e.g., an NMT model) to calculate URL embeddings for each URL among a plurality of URLs that have been classified into URLs for a single domain from a collection of URLs for a plurality of network domains. Each URL embedding being a vector that represents a point in a multidimensional space, and URL embeddings of parallel URLs are closer in value compared with URL embeddings of non-parallel URLs. At operation 424, a loss function is applied to the calculated URL embeddings for each URL among the plurality of URLs to cause similar URL embeddings 335 to converge (in the vector space) while causing dissimilar URL embeddings to diverge, as described in detail above with respect to FIG. 3. At operation 426, the system determines a level of effectiveness of the model in identifying parallel URLs, which correspond to parallel web documents in at least two different languages, by comparing the URL pairs corresponding to the converged similar URL embeddings with a set of ground truth URL pairs. The level of effectiveness, as used herein, refers to the extent to which the URL pairs match the corresponding ground truth URL pairs, thus validating the AI model or marking the AI model for further training or refinement. To prevent an endless cycle of iterations in training or refinement, a cap is placed on the number of cycles for the iterative training process. Based on a determination that the level of effectiveness does not exceed the threshold (e.g., 50, 60, 70, 80, or 90% match between the URL pairs and the ground truth URL pairs) and the number of cycles exceeds a set number of cycles (e.g., 5, 10, 15, 20, 25, 50, 100 cycles or iterations), then the model is ready for runtime URL embedding calculations (at operation 428). The model is also ready for runtime URL embedding calculations (at operation 428) based on a determination that the level of effectiveness exceeds the threshold (e.g., 50, 60, 70, 80, or 90% match between the URL pairs and the ground truth URL pairs).

Where the level of effectiveness does not exceed the threshold (e.g., 50, 60, 70, 80, or 90% match between the URL pairs and the ground truth URL pairs) and the number of cycles does not exceed the set number of cycles (e.g., 5, 10, 15, 20, 25, 50, 100 cycles or iterations), method 400B returns to the process at operation 422. In some examples, prior to returning to the process at operation 422, method 400B proceeds to one or more of the processes at operations 430 and 432, the process at operation 434, and/or the process at 436. At operation 430, one or more sets of synthetic parallel URLs are constructed. As described in detail above with respect to FIG. 3, each set of synthetic parallel URLs includes a first synthetic URL that is a pseudo-URL (or fake URL) constructed from a first sentence in a first language and a second synthetic URL that is a pseudo-URL (or fake URL) constructed from a second sentence in a second language. The second sentence is a translation in the second language of the first sentence. At operation 432, the training data is augmented with the constructed one or more sets of synthetic parallel URLs. Alternatively or additionally, at operation 434, similar to the finetuning process in the refining process at operation 410, the model may be finetuned by maximizing a margin score between cosine similarity values of correct URL sets and cosine similarity values of incorrect URL sets. Alternatively or additionally, at operation 436, sets of parallel URLs whose URLs contain language identifiers are down-sampled in the training data, while up-sampling the training data on sets of parallel URLs whose URLs contain parallel words or parallel phrases.

Turning to example method 400C of FIG. 4C, another run-time operation of the model is shown. At operation 438, a plurality of URLs is classified into URLs for a single network domain (e.g., microsoft.com) from a collection of URLs for a plurality of network domains. The collection of URLs may be contained in a metadata index of a pre-collected archive of web documents. At operation 440, an AI model (e.g., an NMT model or other suitable model) is used to calculate URL embeddings for each URL among the plurality of URLs. Each URL embedding is a vector that represents a point in a multidimensional space, with URL embeddings of parallel URLs being calculated or generated to be closer in value compared with URL embeddings of non-parallel URLs. In examples, the plurality of URLs includes a first subset of URLs corresponding to the first subset of web documents in the source language and a second subset of URLs corresponding to the second subset of web documents in the target language.

At operation 442, a clustering algorithm is used to partition the first subset of URLs into a plurality of clusters. In some examples, the clustering algorithm includes a k-means clustering algorithm. A vector distance is determined, at operation 444, between each URL of the second subset of URLs and a centroid of two or more clusters of the plurality of clusters, based on the corresponding one of the second URL embeddings. At operation 446, for each URL of the second subset of URLs, a cluster among the two or more clusters is identified that is most relevant to said URL, based on the determined vector distance for said URL, and said URL is assigned to the identified cluster. In some cases, computing the vector similarities is performed based on cosine similarity calculations of the plurality of URL embeddings.

At operation 448, vector similarities between first URL embeddings corresponding to a first subset of web documents in a source language and second URL embeddings corresponding to second subset of web documents in a target language are computed. Parallel document candidates are subsequently identified based on the computed vector similarities (at operation 450). In some examples, further refinement may be performed to identify (in some cases, with greater certainty) parallel pairs or sets from among the parallel document candidates. For example, at operation 452, a set of parallel URLs is selected from a set of candidate parallel URLs corresponding to the identified parallel document candidates, by using a weighted bipartite matching algorithm. Other candidate parallel URLs among the set of candidate parallel URLs may be filtered out (at operation 454). At operation 4456, method 400C includes extracting at least one of document text or parallel sentences from web documents corresponding to the selected set of parallel URLs. The extracted at least one of document text or parallel sentences (from operation 456) is then used to train a translation model of a machine language translation system between or among two or more languages (at operation 458). The processes of method 400C is otherwise similar to those of method 400A.

While the techniques and procedures are depicted and/or described in a certain order for purposes of illustration, it should be appreciated that certain procedures may be reordered and/or omitted within the scope of various embodiments. Moreover, while the methods 400A, 400B, and 400C illustrated by FIGS. 4A-4C can be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the methods 400A, 400B, and 400C illustrated by FIGS. 4A-4C (e.g., by executing instructions embodied on a computer readable medium), the systems, examples, or embodiments 100, 200, and 300 of FIGS. 1, 2, and 3 can each also operate according to other modes of operation and/or perform other suitable procedures.

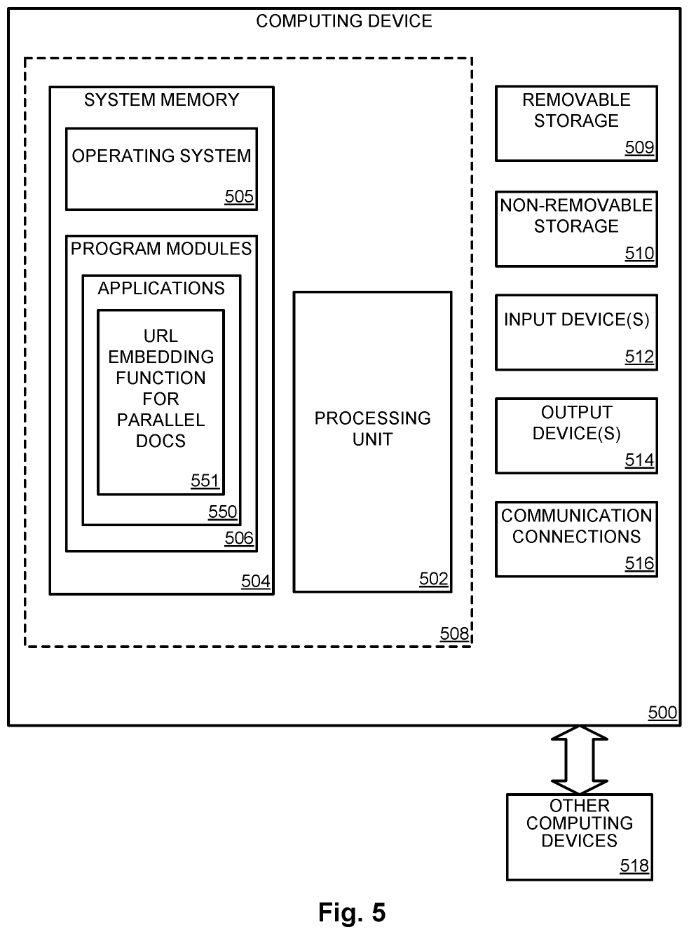

FIG. 5 depicts a block diagram illustrating physical components (i.e., hardware) of a computing device 500 with which examples of the present disclosure may be practiced. The computing device components described below may be suitable for a client device implementing URL embeddings for aligning parallel documents that are corresponding web documents in different languages, as discussed above. In a basic configuration, the computing device 500 may include at least one processing unit 502 and a system memory 504. The processing unit(s) (e.g., processors) may be referred to as a processing system. Depending on the configuration and type of computing device, the system memory 504 may include volatile storage (e.g., random access memory), non-volatile storage (e.g., read-only memory), flash memory, or any combination of such memories. The system memory 504 may include an operating system 505 and one or more program modules 506 suitable for running software applications 550, such as URL embedding function for parallel documents 551, to implement one or more of the systems or methods described above.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionalities. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files may be stored in the system memory 504. While executing on the processing unit 502, the program modules 506 may perform processes including one or more of the operations of the method(s) as illustrated in FIGS. 4A and 4B, or one or more operations of the system(s) and/or apparatus(es) as described with respect to FIGS. 1-3, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (or chip). Examples of the present disclosure may also be practiced using other technologies capable of performing logical operations such as, for example, AND, OR, and NOT, including, but not limited to, mechanical, optical, fluidic, and/or quantum technologies.

The computing device 500 may also have one or more input devices 512 such as a keyboard, a mouse, a pen, a sound input device, and/or a touch input device, etc. The output device(s) 514 such as a display, speakers, and/or a printer, etc. may also be included. The aforementioned devices are examples and others may be used. The computing device 500 may include one or more communication connections 516 allowing communications with other computing devices 518. Examples of suitable communication connections 516 include, but are not limited to, radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, and not limitation, communication media may include wired media such as a wired network or direct-wired connection, and wireless media such as acoustic, RF, infrared, and other wireless media.

As should be appreciated from the foregoing, the present technology provides multiple technical benefits and solutions to technical problems. For instance, training machine language translation models based on parallel documents generally raises multiple technical problems. For instance, one technical problem includes significant resource utilization when embedding content within webpages. Another technical problem includes accurately identifying parallel documents based solely on the URLs themselves. The present technology provides for implementing URL embeddings for aligning parallel documents that are corresponding web pages in different languages, each URL embedding being a vector that represents a point in a multidimensional space with URL embeddings of parallel URLs being closer in value compared with URL embeddings of non-parallel URLs. In examples, a pre-trained AI model (e.g., an NMT model) is used to calculate the URL embeddings for each URL among a plurality of URLs, which may include URLs within a single domain. In some cases, the plurality of URLs is partitioned into clusters, using a clustering algorithm applied to URL embeddings of the plurality of URLs, resulting in a second plurality of URLs in a single cluster. The system identifies, based on closeness of the points represented by the URL embeddings, a set of candidate parallel URLs by either analyzing the URL embeddings for the plurality of URLs or analyzing the URL embeddings for the second plurality of URLs. A set of parallel URLs, associated with the parallel documents, is selected from the identified set of candidate parallel URLs. Document text and/or parallel sentences are extracted from web documents associated with the set of parallel URLs to train a machine translation model for translating between two or more languages.

In an aspect, the technology relates to a system for implementing URL embeddings for aligning parallel documents that are corresponding web pages in different languages. The system includes a processing system, and memory coupled to the processing system, the memory including computer executable instructions that, when executed by the processing system, causes the system to perform operations. In examples, the operations include calculating, using an AI model, URL embeddings for each URL among a plurality of URLs to produce a plurality of URL embeddings for host portions of the plurality of URLs, the plurality of URLs corresponding to web documents in at least two different languages. The operations further include computing vector similarities between first URL embeddings corresponding to a first subset of web documents in a source language and second URL embeddings corresponding to second subset of web documents in a target language; and identifying parallel document candidates based on the computed vector similarities.

In some examples, the plurality of URLs includes URLs that have been classified into URLs for a single network domain from a collection of URLs, for a plurality of network domains, that is contained in a metadata index of a pre-collected archive of web documents. In some cases, the metadata index includes a language identification token for a URL of at least a subset of the web documents in the pre-collected archive. In some instances, the operations further include, based on the language identification token, identifying the first URL embeddings corresponding to a first subset of web documents in the source language and identifying the second URL embeddings corresponding to second subset of web documents in the target language. In some examples, each URL is further embedded with a language identification token indicating to which of three or more languages the web documents associated with said URL corresponds. The second URL embeddings include two or more second URL embeddings correspond to web documents in two or more target languages. In some cases, computing vector similarities includes computing vector similarities between the first URL embeddings corresponding to web documents in the source language and each of the two or more second URL embeddings each corresponding to web documents in one of the two or more target languages.

In examples, the plurality of URLs includes a first subset of URLs corresponding to the first subset of web documents in the source language and a second subset of URLs corresponding to the second subset of web documents in the target language. In some examples, the operations further include partitioning, using a clustering algorithm, the first subset of URLs into a plurality of clusters; and determining a vector distance between each URL of the second subset of URLs and a centroid of two or more clusters of the plurality of clusters, based on the corresponding one of the second URL embeddings. In some cases, the operations further include, for each URL of the second subset of URLs, identifying a cluster among the two or more clusters that is most relevant to said URL based on the determined vector distance for said URL, and assigning said URL to the identified cluster. In some instances, the clustering algorithm includes a k-means clustering algorithm. In some cases, computing the vector similarities is performed based on cosine similarity calculations of the plurality of URL embeddings.

In some examples, the operations further include selecting a set of parallel URLs from a set of candidate parallel URLs corresponding to the identified parallel document candidates, by using a weighted bipartite matching algorithm; and filtering out other candidate parallel URLs among the set of candidate parallel URLs. In some instances, the weighted bipartite matching algorithm includes a competitive linking algorithm. In some cases, the competitive linking algorithm uses weights that represent a quality of the set of parallel URLs. In some examples, the weights are calculated as a margin score based on a highest scoring URL pair and a plurality of other high-scoring URL pairs.

In examples, the operations further include extracting at least one of parallel document text or parallel sentences from web documents corresponding to the selected set of parallel URLs; and training a translation model of a machine language translation system among two or more languages using the extracted at least one of parallel document text or parallel sentences.

In another aspect, the technology relates to a computer-implemented method for implementing URL embeddings for aligning parallel documents that are corresponding web pages in different languages. The computer-implemented method includes calculating, using an AI model, URL embeddings for each URL among a plurality of URLs that have been classified into one domain among a plurality of domains. The plurality of URLs includes a first subset of URLs corresponding to a first subset of web documents in a source language and a second subset of URLs corresponding to a second subset of web documents in a target language. The computer-implemented method further includes partitioning, using a clustering algorithm, the first subset of URLs into a plurality of clusters; and assigning one or more URLs among the second subset of URLs into a cluster of the plurality of clusters, based on closeness of the points represented by the URL embeddings of the one or more URLs to a centroid of the cluster. The computer-implemented method further includes identifying a set of candidate parallel URLs by analyzing the URL embeddings for the one or more URLs that have been assigned to the cluster; and selecting a set of parallel URLs from the identified set of candidate parallel URLs. The set of parallel URLs may be associated with parallel documents that are corresponding web documents in at least two different languages. The computer-implemented method further includes extracting at least one of document text or parallel sentences from web documents corresponding to the parallel URLs; and training a machine translation model with the extracted at least one of document text or parallel sentences.

In some examples, the AI model includes an encoder model of a pre-trained NMT model. In some cases, the plurality of URLs includes URLs that have been classified into URLs for a single network domain from a collection of URLs, for a plurality of network domains, that is contained in a metadata index of a pre-collected archive of web documents. In some instances, the metadata index includes a language identification token for a URL of at least a subset of the web documents in the pre-collected archive, and identifying the set of candidate parallel URLs includes identifying based on the language identification token for the at least a subset of the web documents. In some cases, the clustering algorithm includes k-means clustering algorithm.

In examples, the computer-implemented method further includes applying a linking algorithm to the identified set of candidate parallel URLs to apply an estimated relevance weight value to each URL in the identified set of candidate parallel URLs; and filtering out least relevant URLs from the identified set of candidate parallel URLs based on the estimated relevance weight value that is applied to each URL. In some cases, selecting the set of parallel URLs includes selecting remaining URLs after filtering.

In yet another aspect, the technology relates to a system including a processing system and memory coupled to the processing system. The memory includes computer executable instructions that, when executed by the processing system, causes the system to perform operations. In examples, the operations include training, using one or more sets of parallel URLs as training data, an AI model to calculate URL embeddings for each URL, wherein URL embeddings of parallel URLs are closer in value compared with URL embeddings of non-parallel URLs. The operations further include applying a loss function to the calculated URL embeddings for each URL among the plurality of URLs to cause similar URL embeddings to converge while causing dissimilar URL embeddings to diverge; and determining a level of effectiveness of the AI model in identifying parallel URLs that correspond to web documents in at least two different languages. The operations further include repeating the processes of training the AI model to calculate URL embeddings for each URL, applying the loss function, and determining the level of effectiveness of the AI model either for a set number of cycles or until the determined level of effectiveness exceeds a threshold level of effectiveness.

In examples, the operations further include constructing one or more sets of synthetic parallel URLs. Each set of synthetic parallel URLs includes a first synthetic URL that is a pseudo-URL constructed from a first sentence in a first language and a second synthetic URL that is a pseudo-URL constructed from a second sentence in a second language. The second sentence may be a translation in the second language of the first sentence. The operations further include augmenting the training data with the constructed one or more sets of synthetic parallel URLs. In some cases, the operations further include finetuning the AI model by maximizing a margin score between cosine similarity values of correct URL sets and cosine similarity values of incorrect URL sets. In some instances, the operations further include down-sampling, in the training data, sets of parallel URLs whose URLs differ only by language identifiers, while up-sampling the training data on sets of parallel URLs whose URLs contain parallel words or parallel phrases. In some examples, determining the level of effectiveness of the AI model includes comparing URL pairs corresponding to converged similar URL embeddings with corresponding ground truth URL pairs.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A system for implementing uniform resource locator (“URL”) embeddings for aligning parallel documents that are corresponding web pages in different languages, the system comprising:
a processing system; and
memory coupled to the processing system, the memory comprising computer executable instructions that, when executed by the processing system, causes the system to perform operations comprising:
calculating, using an artificial intelligence (“AI”) model, URL embeddings for each URL among a plurality of URLs to produce a plurality of URL embeddings for host portions of the plurality of URLs, the plurality of URLs corresponding to web documents in at least two different languages;
computing vector similarities between first URL embeddings corresponding to a first subset of web documents in a source language and second URL embeddings corresponding to second subset of web documents in a target language; and
identifying parallel document candidates based on the computed vector similarities.

2. The system of claim 1, wherein the plurality of URLs are URLs that have been classified into URLs for a single network domain from a collection of URLs, for a plurality of network domains, that is contained in a metadata index of a pre-collected archive of web documents.

3. The system of claim 2, wherein the metadata index includes a language identification token for a URL of at least a subset of the web documents in the pre-collected archive, wherein the operations further comprise:
based on the language identification token, identifying the first URL embeddings corresponding to a first subset of web documents in the source language and identifying the second URL embeddings corresponding to second subset of web documents in the target language.

4. The system of claim 2, wherein each URL is further embedded with a language identification token indicating to which of three or more languages the web documents associated with said URL corresponds, wherein the second URL embeddings comprise two or more second URL embeddings correspond to web documents in two or more target languages, wherein computing vector similarities comprises computing vector similarities between the first URL embeddings corresponding to web documents in the source language and each of the two or more second URL embeddings each corresponding to web documents in one of the two or more target languages.

5. The system of claim 1, wherein the plurality of URLs comprises a first subset of URLs corresponding to the first subset of web documents in the source language and a second subset of URLs corresponding to the second subset of web documents in the target language, wherein the operations further comprise:
partitioning, using a clustering algorithm, the first subset of URLs into a plurality of clusters;
determining a vector distance between each URL of the second subset of URLs and a centroid of two or more clusters of the plurality of clusters, based on the corresponding one of the second URL embeddings; and
for each URL of the second subset of URLs, identifying a cluster among the two or more clusters that is most relevant to said URL based on the determined vector distance for said URL, and assigning said URL to the identified cluster.

6. The system of claim 5, wherein the clustering algorithm comprises a k-means clustering algorithm.

7. The system of claim 5, wherein computing the vector similarities is performed based on cosine similarity calculations of the plurality of URL embeddings.

8. The system of claim 1, wherein the operations further comprise:
selecting a set of parallel URLs from a set of candidate parallel URLs corresponding to the identified parallel document candidates, by using a weighted bipartite matching algorithm; and
filtering out other candidate parallel URLs among the set of candidate parallel URLs.

9. The system of claim 8, wherein the weighted bipartite matching algorithm comprises a competitive linking algorithm.

10. The system of claim 9, wherein the competitive linking algorithm uses weights that represent a quality of the set of parallel URLs.

11. The system of claim 10, wherein the weights are calculated as a margin score based on a highest scoring URL pair and a plurality of other high-scoring URL pairs.

12. The system of claim 1, wherein the operations further comprise:
extracting at least one of parallel document text or parallel sentences from web documents corresponding to the selected set of parallel URLs; and
training a translation model of a machine language translation system among two or more languages using the extracted at least one of parallel document text or parallel sentences.

13. A computer-implemented method for implementing uniform resource locator (“URL”) embeddings for aligning parallel documents that are corresponding web pages in different languages, the computer-implemented method comprising:
calculating, using an artificial intelligence (“AI”) model, URL embeddings for each URL among a plurality of URLs that have been classified into one domain among a plurality of domains, the plurality of URLs comprising a first subset of URLs corresponding to a first subset of web documents in a source language and a second subset of URLs corresponding to a second subset of web documents in a target language;
partitioning, using a clustering algorithm, the first subset of URLs into a plurality of clusters;
assigning one or more URLs among the second subset of URLs into a cluster of the plurality of clusters, based on closeness of the points represented by the URL embeddings of the one or more URLs to a centroid of the cluster;
identifying a set of candidate parallel URLs by analyzing the URL embeddings for the one or more URLs that have been assigned to the cluster;
selecting a set of parallel URLs from the identified set of candidate parallel URLs, the set of parallel URLs being associated with parallel documents that are corresponding web documents in at least two different languages;
extracting at least one of document text or parallel sentences from web documents corresponding to the parallel URLs; and
training a machine translation model with the extracted at least one of document text or parallel sentences.

14. The computer-implemented method of claim 13, wherein:
the AI model comprises an encoder model of a pre-trained neural machine translation (“NMT”) model;
the plurality of URLs are URLs that have been classified into URLs for a single network domain from a collection of URLs, for a plurality of network domains, that is contained in a metadata index of a pre-collected archive of web documents;
the metadata index includes a language identification token for a URL of at least a subset of the web documents in the pre-collected archive, and identifying the set of candidate parallel URLs comprises identifying based on the language identification token for the at least a subset of the web documents; and
the clustering algorithm comprises k-means clustering algorithm.

15. The computer-implemented method of claim 13, further comprising:
applying a linking algorithm to the identified set of candidate parallel URLs to apply an estimated relevance weight value to each URL in the identified set of candidate parallel URLs; and
filtering out least relevant URLs from the identified set of candidate parallel URLs based on the estimated relevance weight value that is applied to each URL;
wherein selecting the set of parallel URLs comprises selecting remaining URLs after filtering.

16. A system, comprising:
a processing system; and
memory coupled to the processing system, the memory comprising computer executable instructions that, when executed by the processing system, causes the system to perform operations comprising:
training, using one or more sets of parallel uniform resource locators (“URLs”) as training data, an artificial intelligence (“AI”) model to calculate URL embeddings for each URL, wherein URL embeddings of parallel URLs are closer in value compared with URL embeddings of non-parallel URLs;
applying a loss function to the calculated URL embeddings for each URL among the plurality of URLs to cause similar URL embeddings to converge while causing dissimilar URL embeddings to diverge;
determining a level of effectiveness of the AI model in identifying parallel URLs that correspond to web documents in at least two different languages; and
repeating the processes of training the AI model to calculate URL embeddings for each URL, applying the loss function, and determining the level of effectiveness of the AI model either for a set number of cycles or until the determined level of effectiveness exceeds a threshold level of effectiveness.

17. The system of claim 16, wherein the operations further comprise:
constructing one or more sets of synthetic parallel URLs, wherein each set of synthetic parallel URLs comprises a first synthetic URL that is a pseudo-URL constructed from a first sentence in a first language and a second synthetic URL that is a pseudo-URL constructed from a second sentence in a second language, the second sentence being a translation in the second language of the first sentence; and
augmenting the training data with the constructed one or more sets of synthetic parallel URLs.

18. The system of claim 16, wherein the operations further comprise:
finetuning the AI model by maximizing a margin score between cosine similarity values of correct URL sets and cosine similarity values of incorrect URL sets.

19. The system of claim 16, wherein the operations further comprise:
down-sampling, in the training data, sets of parallel URLs whose URLs differ only by language identifiers, while up-sampling the training data on sets of parallel URLs whose URLs contain parallel words or parallel phrases.

20. The system of claim 16, wherein determining the level of effectiveness of the AI model comprises:
comparing URL pairs corresponding to converged similar URL embeddings with corresponding ground truth URL pairs.
